(19) United States
(12) Patent Application Publication
(10) Pub. No.: US 2013/0282815 A1
(43) Pub. Date: Oct. 24, 2013

(54) HANDHELD DEVICE AND METHOD FOR TRANSMITTING SHARED DATA

(71) Applicants: HONG FU JIN PRECISION INDUSTRY (ShenZhen) CO., LTD., (US); HON HAI PRECISION INDUSTRY CO., LTD., New Taipei (TW)

(72) Inventor: CHANG-WU DU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/784,851

(22) Filed: Mar. 5, 2013

(30) Foreign Application Priority Data
Apr. 20, 2012 (CN) 201210118904.5

(51) Int. Cl. H04W 8/24

(52) U.S. Cl. CPC H04W 8/24
USPC 709/204

(57) ABSTRACT

A handheld device transmits a shared data to another handheld device. The handheld device sets the shared data according to a selection of a user, sends an authentication signal to the another handheld device, and detects a motion track of the handheld device. The handheld device further receives another motion track of the another handheld device from the another handheld device, compares the received motion track with the detected motion track, determines whether the another handheld device is authenticated according to a result of the comparison. The handheld device further transmits the shared data to the another handheld device when the another handheld device is authenticated.

### BACKGROUND

1. Technical Field

Embodiments of the present disclosure generally relate to handheld devices, and more particularly to a method for transmitting shared data between two handheld devices.

2. Description of Related Art

Currently, BLUETOOTH is used for transmitting the shared data between two handheld devices. In this method, one handheld device needs to transmit an authentication code to another handheld device for pairing with each other before receiving the shared data. Users of the handheld devices have to remember the authentication code, which is inconvenient. Therefore, a method that simplifies the procedure of pairing is needed.

### BRIEF DESCRIPTION OF THE DRAWINGS

FIG. 1 is a schematic diagram of one embodiment of an application environment and functional modules of a handheld device in accordance with the present disclosure.

FIG. 2 is a flowchart of one embodiment of transmitting shared data method in accordance with the present disclosure.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, JAVA, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

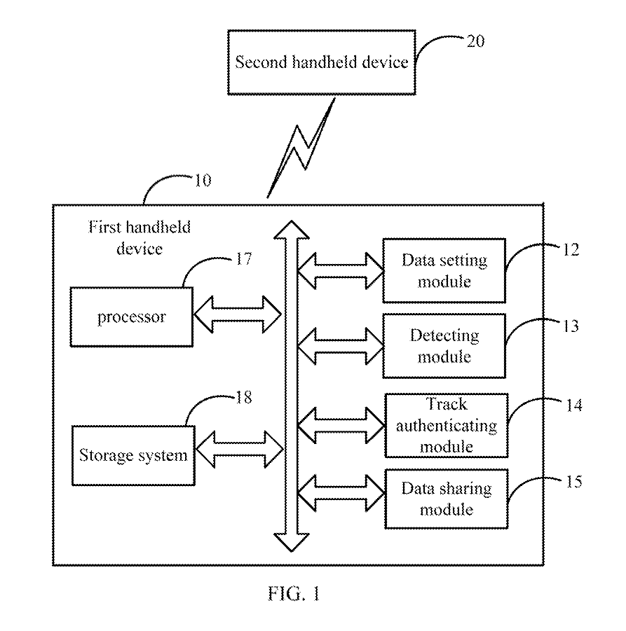

FIG. 1 is a schematic diagram of one embodiment of an application environment and functional modules of a first handheld device 10 in accordance with the present disclosure. As referred in FIG. 1, the first handheld device 10 transmits shared data to a second handheld device 20 after pairing with the second handheld device 20. The method of pairing will be described in the present disclosure in detail. The first handheld device 10 and the second handheld device 20 may be the different type devices, such as, one is a mobile phone, another is a tablet, or in a contrary manner. However, the first handheld device 10 and the second handheld device 20 may also be the same type, such as both being mobile phones or tablets.

In one embodiment of the present disclosure, the first handheld device 10 includes a data setting module 12, a detecting module 13, a track authenticating module 14, a data sharing module 15, a processor 17, and a storage system 18. In one embodiment, the modules 12-14 may comprise computerized code in the form of one or more programs that are stored in the storage system 18. The computerized code includes instructions that are executed by the processor 17 to provide functions for the modules 12-14. In one example, the storage system 18 may include a hard disk drive, a flash memory, a cache or another computerized memory device.

The data setting module 12 sets the shared data. In one embodiment, the shared data may be one file to share with the second handheld device 20 or a plurality files to respectively share with a plurality of the second handheld devices 20. The data setting module 12 further sets a first data transmission mode and a second data transmission mode. The first data transmission mode defines that the data sharing module 15 sends the shared data to the second handheld device 20 directly after the second handheld device 20 is authenticated. However, the second data transmission mode defines that the data sharing module 15 queries a user whether to start to send the shared data to the second handheld device 20 and sends the shared data to the second handheld device when the user decides to send the shared data to the second handheld device 20.

In one embodiment, a dialog box will be displayed on the first handheld device 10 after the second handheld device 20 is authenticated when the first handheld device 10 is set the second data transmission mode, the dialog box is used to query the user whether to start to send the shared data to the second handheld device 20. A difference between the first data transmission mode and the second data transmission mode is whether need to further confirm to start to transmit the shared data to the second handheld device 20 after the second handheld device 20 is authenticated. Data sent between the first handheld device 10 and the second handheld device 20 may be fast in the first data transmission mode for there is no need to further confirm, and the user may selects the first data transmission mode when the data is not very important. However, if the data is very important, the second data transmission mode is a more optimum selection for it need to further confirm, which can avoid transmitting mistakenly effectively.

The detecting module 13 sends an authentication signal to the second handheld device 20 when the data setting module 12 has set the shared data, and detects a motion track of the first handheld device 10 by a sensor. The motion track of the first handheld device 10 is generated by shaking the first handheld device 10 in an uncertain direction.

The track authenticating module 14 receives another motion track of the second handheld device 20 from the second handheld device 20. In one embodiment, the another motion track of the second handheld device 20 includes a first kind motion track and a second kind motion track. The first kind motion track is generated by shaking the second handheld device 20 imitating the motion track of the first handheld device 10. The second kind motion track is generated by shaking the second handheld device 20 attached to the first handheld device. If the first handheld device 10 and the second handheld device 20 both are small, the another motion track can be generated by random ways of the two, and if any one of the first handheld device 10 and the second handheld device 20 is large, the generating way of the first kind motion track is more convenient.

The track authenticating module 14 compares the another motion track with the motion track detected by the detecting module 13. The track authenticating module 14 further determines whether the second handheld device 20 is authenticated according to the result of the comparison. In one embodiment, the track authenticating module 14 determines that the second handheld device 20 is authenticated if the another motion track generated by the second handheld device 20 is substantially the same with the motion track generated by the first handheld device 10. In other embodiment, the track authenticating module 14 determines that the second handheld device 20 is authenticated if a similarity of the another motion track generated by the second handheld device 20 and the motion track generated by the first handheld device 10 exceeds a threshold. In one embodiment, the threshold may be 80%, 90%, 98%. If the threshold is 98%, the second kind motion track generated by shaking the second handheld device 20 attached to the first handheld device is realized more easily.

The data sharing module 15 transmits the shared data to the second handheld device 20 when the second handheld device 20 is authenticated. The data sharing module 15 further saves a transmission breaking point of the shared data when the transmission of the shared data is broken, and transmits the shared data to the second handheld device 20 from the transmission breaking point next time, which can be more effective. In the embodiment, if there are several second handheld devices, the first handheld device 10 also can transmit the shared data to them at the same time.

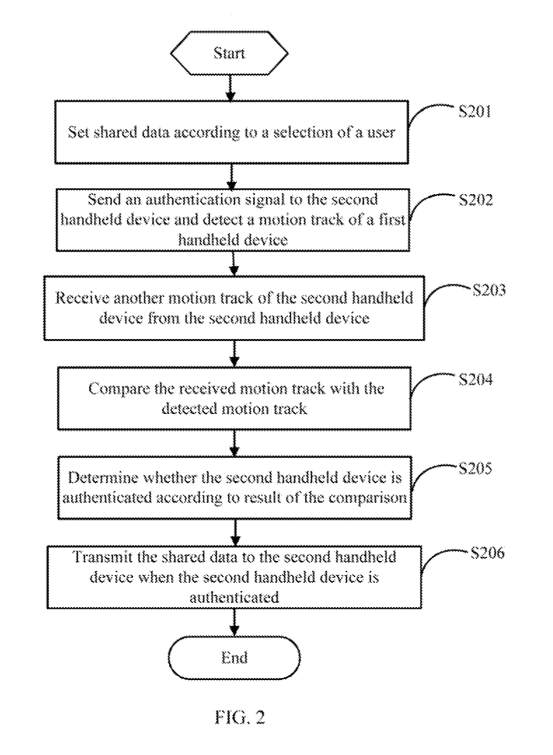

FIG. 2 shows one embodiment of transmitting the shared data method of the first handheld device 10. In the embodiment, the shared data transmitting method is executed by the functional modules of FIG. 1 in the manner of following.

In one embodiment, the first handheld device 10 establishes pairing with the second handheld device 20 via a motion track authenticating process, and sends the shared data to the second handheld device 20 when the second handheld device 20 is authenticated.

In block S201, the data setting module 12 sets the shared data according to a selection of a user. The data setting module 12 further sets a first data transmission mode and a second transmission mode. The first data transmission mode defines that the data sharing module 15 sends the shared data to the second handheld device 20 directly after the another handheld device 20 is authenticated. However, the second data transmission mode defines that the data sharing module 15 queries the user whether to start to send the shared data to the second handheld device 20 and sends the shared data to the second handheld device 20 when the user decides to send the shared data to the second handheld device 20.

In block S202, the detecting module 13 sends a authentication signal to the second handheld device 20 and detects a motion track of the first handheld device 10 by a sensor. The motion track of the first handheld device 10 is generated by shaking the first handheld device 10 in an uncertain direction.

In block S203, the track authenticating module 14 receives another motion track of the second handheld device 20 from the second handheld device 20. The another motion track of the second handheld device 20 includes a first kind motion track and a second kind motion track, the first kind motion track is generated by shaking the second handheld device 20 imitating the motion track of the first handheld device 10, and the second kind motion track is generated by shaking the second handheld device 20 attached to first handheld device 10.

In block S204, the track authenticating module 14 further compares the another motion track with the motion track detected by the detecting module 13.

In block S205, the track authenticating module 14 further determines whether the another motion track is authenticated according to the result of the comparison. In one embodiment, the first handheld device 10 determines that the second handheld device 20 is authenticated if the another motion track generated by the second handheld device 20 is substantially the same with the motion track generated by the first handheld device 10. In other embodiment, the track authenticating module 14 determines that the second handheld device 20 is authenticated if a similarity of the another motion track generated by the second handheld device 20 and the motion track generated by the first handheld device 10 exceeds a threshold.

In block S206, the data sharing module 15 transmits the shared data to the second handheld device 20 when the second handheld device 20 is authenticated. Furthermore, the data sharing module 15 saves a transmission breaking point of the shared data when the transmission of the shared data is broken, and transmits the shared data to the second handheld device 20 from the transmission breaking point next time.

Therefore, the first handheld device 10 can transmit the shared data to the second handheld device 20 via a motion track authenticating, which is more simple and convenient for users.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A handheld device, transmitting shared data with another handheld device, comprising:
a processor;
a storage system electronically connected to the processor;
one or more programs that are stored in the storage system and are executed by the processor, comprising:
a data setting module, setting the shared data according to a selection of a user;
a detecting module, sending an authentication signal to the another handheld device, and detecting a motion track of the handheld device;
a track authenticating module, receiving another motion track of the another handheld device from the another handheld device, comparing the received motion track with the detected motion track, determining whether the another handheld device is authenticated according to a result of the comparison; and
a data sharing module, transmitting the shared data to the another handheld device when the another handheld device is authenticated.

2. The handheld device as claimed in claim 1, wherein the data setting module further sets a first data transmission mode, wherein the first data transmission mode defines that the data sharing module sends the shared data to the another handheld device directly after the another handheld device is authenticated.

3. The handheld device as claimed in claim 1, wherein the data setting module further sets a second data transmission mode, wherein the second data transmission mode defines that the data sharing module queries the user whether to start to send the shared data to the another handheld device and sends the shared data to the another handheld device when the user decides to send the shared data to the another handheld device.

4. The handheld device as claimed in claim 1, wherein the motion track of the handheld device is generated by shaking the handheld device in an uncertain direction.

5. The handheld device as claimed in claim 4, wherein the another motion track of the another handheld device comprises a first kind motion track and a second kind motion track, wherein the first kind motion track is generated by shaking the another handheld device imitating the motion track of the handheld device, and the second kind motion track is generated by shaking the another handheld device attached to the handheld device.

6. The handheld device as claimed in claim 1, wherein the track authenticating module determines that the another handheld device is authenticated if the another motion track generated by the another handheld device is substantially the same with the motion track generated by the handheld device, or a similarity of the another motion track generated by the another handheld device and the motion track generated by the handheld device exceeds a threshold.

7. The handheld device as claimed in claim 1, when the transmission of the shared data is broken, the data sharing module further saves a transmission breaking point of the shared data, and transmits the shared data to the another handheld device from the transmission breaking point next time.

8. A shared data transmitting method between a first handheld device and a second handheld device, the method comprising:
setting the shared data according to a selection of a user;
sending an authentication signal to the second handheld device, and detecting a motion track of the first handheld device;
receiving another motion track of the second handheld device from the second handheld device;
comparing the received motion track with the detected motion track;
determining whether the second handheld device is authenticated according to a result of the comparison; and
transmitting the shared data to the second handheld device when the second handheld device is authenticated.

9. The shared data transmitting method as claimed in claim 8, further comprising:
setting a first data transmission mode, wherein the first data transmission mode defines that the data sharing module sends the shared data to the second handheld device directly after the second handheld device is authenticated.

10. The shared data transmitting method as claimed in claim 8, further comprising:
setting a second data transmission mode, wherein the second data transmission mode defines that the data sharing module queries the user whether to start to send the shared data to the second handheld device and sends the shared data to the second handheld device when the user decides to send the shared data to the second handheld device.

11. The shared data transmitting method as claimed in claim 8, the motion track of the first handheld device generated by shaking the first handheld device in an uncertain direction.

12. The shared data transmitting method as claimed in claim 11, the another motion track of the second handheld device comprises a first kind motion track and a second kind motion track, wherein the first kind motion track generated by shaking the second handheld device imitating the motion track of the first handheld device, and the second kind motion track generated by shaking the second handheld device attached to the first handheld device.

13. The shared data transmitting method as claimed in claim 8, further comprising:
determining that the second handheld device is authenticated if the another motion track generated by the second handheld device is substantially the same with the motion track generated by the first handheld device, or a similarity of the another motion track generated by the second handheld device and the motion track generated by the first handheld device exceeds a threshold.

14. The shared data transmitting method as claimed in claim 8, further comprising:
saving a transmission breaking point of the shared data when the transmission of the shared data is broken; and
transmitting the shared data to the second handheld device from the transmission breaking point next time.
